(19) United States
(12) Patent Application Publication
(10) Pub. No.: US 2009/0099885 A1
(43) Pub. Date: Apr. 16, 2009

(54) METHOD FOR RISK ANALYSIS USING INFORMATION ASSET MODELLING

(76) Inventors: Yune-Gie Sung, Yongin-si (KR); Won-Tae Sim, Seongnam-si (KR); Woo-Han Kim, Seoul (KR)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(21) Appl. No.: 11/941,209

(22) Filed: Nov. 16, 2007

(30) Foreign Application Priority Data
Oct. 12, 2007 (KR) 10-2007-0102880

(51) Int. Cl. G06Q 10/00

(52) U.S. Cl. 705/7

(57) ABSTRACT

A method for risk analysis using information asset modeling. The method has the steps of: (a) identifying an information asset which uses or provides a network service; (b) identifying a threat on the information asset through a computer network; (c) identifying a vulnerability of the information asset; (d) calculating an AL (attack likelihood) by using a CVSS (Common Vulnerability Scoring System) score obtained by converting a severity caused by a success of an attack on the vulnerability into a standardized value; (e) computing the value of the information asset so as to calculate an IM (impact analysis); and (f) multiplying the calculated AL and IM so as to determine an RL (risk level) for the information asset.

### CROSS-REFERENCE TO RELATED APPLICATION

This application claims all benefits of Korean Patent Application No. 10-2007-0102880 filed on Oct. 12, 2007 in the Korean Intellectual Property Office, the disclosures of which are incorporated herein by reference.

### BACKGROUND OF THE INVENTION

1. Field of the invention

The present invention relates to a method for risk analysis using information asset modeling, and more specifically, to a method for risk analysis which identifies and models an information asset, on which the risk analysis is desired to be performed, such that risk calculation for the information asset can be automated.

2. Description of the Prior Art

Risk analysis or risk evaluation is an element required for maintaining or measuring the security of an organization. When an organization is exposed to a risk, an effect on the task performance of the organization is grasped through the risk analysis. Accordingly, proper control and protection measures can be guaranteed.

As Internet infrastructures are spread and services of companies using computer systems are remarkably expanded, risk analysis from the viewpoint of an attack using a computer network is required.

Recently, public institutions as well as private corporations such as banking facilities, Internet portal sites, communication companies, Internet shopping malls, and so on utilize information infrastructures so as to provide a variety of services. Accordingly, more and more organizations utilize a qualitative risk analysis method so as to perform vulnerability analysis, risk analysis, and evaluation for information assets. Through this, the organizations judge a risk so as to apply a protection measure. Therefore, the assets of the organizations can be protected, and the tasks thereof can be performed safely.

Determining the range of risk evaluation starts from the determining of the range of assets which are targets of the risk evaluation. That is, the range of assets may be set as the overall operation assets of an organization including persons, buildings, IT systems, documents, and so on, or limited to IT assets including hardwares and softwares. However, it is difficult to grasp formless information assets such as services or data included in computers, among the assets.

In general, a qualitative risk evaluation tool is composed of a model which is input by a system administrator or an expert so as to calculate a risk. To find out vulnerability after identifying an asset, risk evaluation experts examine various elements ranging from design to implementation contents and use various methods such as an intrusion test, and so on. However, when a system engineer, a network operator, and a manager manually perform the method, a lot of time is taken. Further, there are difficulties in managing vulnerability information consistently.

### SUMMARY OF THE INVENTION

An object of the present invention is to provide a method for risk analysis using information asset modeling, which automates the identification of information assets and utilizes a CVSS (Common Vulnerability Scoring System) so as to minimize the intervention of an expert or an operator.

According to an aspect of the present invention, a method for risk analysis using information asset modeling includes the steps of: (a) identifying an information asset which uses or provides a network service; (b) identifying a threat on the information asset through a computer network; (c) identifying a vulnerability of the information asset; (d) calculating an AL (attack likelihood) using a CVSS (Common Vulnerability Scoring System) score obtained by converting a severity caused by a success of an attack on the vulnerability into a standardized value; (e) computing the value of the information asset so as to calculate an IM (impact analysis); and (f) multiplying the calculated AL and IM so as to determine an RL (risk level) for the information asset.

In step (c), CVE (Common Vulnerabilities & Exposures) identifiers may be used.

The method further includes the step of extracting a CVSS score from the CVE information, the CVSS score being obtained by scoring the vulnerability. The extracting of the CVSS score is performed between steps (c) and (d).

Step (e) may include the steps of: checking an identifier of the information asset for the vulnerability; checking a service provided by the information asset and software operated by the information asset; and checking a traffic ratio used in the checked service and software so as to compute the value of the information asset.

The traffic may include information on the number of visitors who get access to the information asset through an Internet site.

Further, a path of the threat on the information asset may be a logic access through the computer network.

### BRIEF DESCRIPTION OF THE DRAWINGS

The above and other objects, features and advantages of the present invention will be more apparent from the following detailed description taken in conjunction with the accompanying drawing:

FIG. 1 is a flow chart showing a method for risk analysis according to an embodiment of the present invention.

### DETAILED DESCRIPTION OF EMBODIMENTS

Hereinafter, a method for risk analysis according to an embodiment of the present invention will be described with reference to the accompanying drawing.

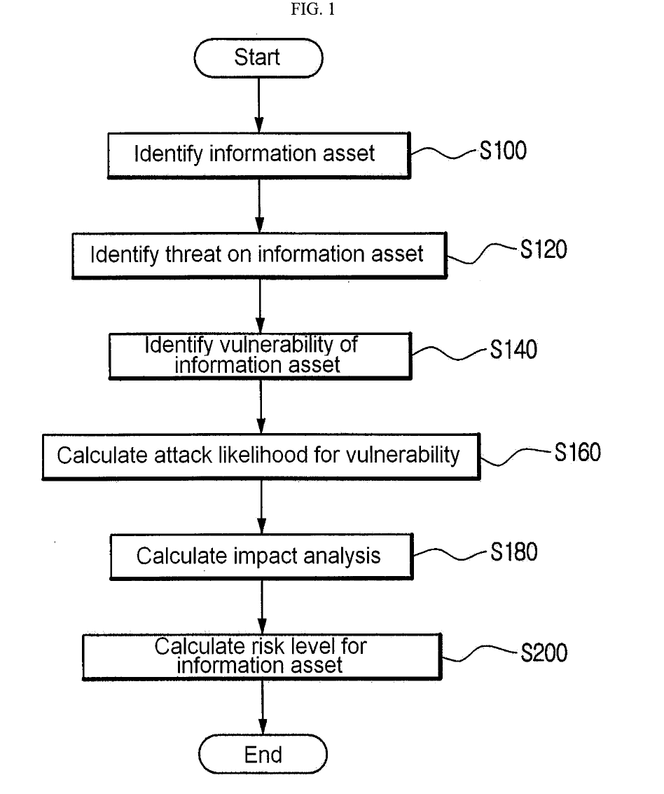

FIG. 1 is a flow chart showing a method for risk analysis according to an embodiment of the present invention.

Referring to FIG. 1, the method for risk analysis is performed as follows. First, an information asset among assets of an organization is identified (step S100).

Differently from a physical asset, the information asset has such a property that the existence or non-existence thereof changes in real time when viewed from the point of an external user. Further, if the information asset is not connected to a computer network and service is not provided, it is not grasped by a remote user. In this case, since an external user cannot get access to the information asset, a risk does not exist. The existence of physical asset is visible, and the physical asset is carried out for a predetermined purpose, whereas there is a large variation in whether or not to operate the information asset, depending on time and purpose. Therefore, an actual operation state of the information asset should be grasped in real time.

Further, the identification of information asset can be divided into the identification of information asset and the individual identification of elements composing the information asset. In general, a hacker first grasps through a tool whether a computer as an attack target exists or not. Next, the hacker grasps sub-elements of the computer, that is, an operating system of the computer, services currently provided by the computer, the software version of each service, and so on. Then, the hacker searches for a vulnerability corresponding to the received software information so as to intrude into the computer.

The collection of the information asset should be performed depending on two concepts. That is, the information asset is divided into an asset viewed from the point of an identifier representative of the asset and an external user and element information viewed from the point of an interacting user. To collect the information, an Nmap (Network Mapper) or a network packet analysis may be used.

Subsequently, after the information asset is identified (step S100), a threat on the information asset through a computer network is identified (step S120). The threat is defined as an action where a hacker from the outside of the organization intentionally discloses, falsifies, destroys, and/or interrupts the information.

With regard to the threat, a method is considered, in which a hacker attacks an asset in a remote location by using a vulnerability of a computer. In this case, a threat source intentionally accesses a computer of the organization from outside, and then finds out a vulnerability owned by the computer while interacting with the computer. Then, the threat source exploits the vulnerability so as to infringe the confidentiality, integrity, and availability of the computer.

A threat path can be classified into a logic access, a physical access, a problem on a system, and other problems. Further, a threat occurrence case can be classified depending on an access method, a threat subject, a motive, an infringe result, and so on.

In the present invention, a logic access through a computer network may be considered as the threat path, based on automatic identification of information assets.

After the threat is identified (step S120), a vulnerability of the information asset is identified (step S140). A vulnerability in a computer field is defined as a defect in the design, implementation, operation, and/or management of a system, which may be exploited to violate a security policy of the system.

The vulnerability includes a vulnerable implementation logic or algorithm which may occur in designing, an error occurring in implementing, and an error occurring when the system is set up or operated. If such information is exposed so as to be exploited, the system does not normally perform an intended security function, and the system or data may be infringed by an external hacker.

In an embodiment of the invention, CVE (Common Vulnerabilities & Exposures) identifiers are used so as to identify vulnerabilities of an information asset. The CVE is a name list which is provided by MITRE and is standardized for security vulnerabilities and other information security exposures. The CVE includes standardized names relating to all security vulnerabilities and exposures, which are known thus far.

When the CVE information is used, vulnerability information can be managed uniformly and consistently. A vulnerability for an information asset can be searched referring to the dictionary provided by the CVE. Further, the vulnerability is stored in a database, and software which is being operated in a corresponding system is then grasped. In this case, the vulnerability owned by the information asset can be easily perceived.

Subsequently, an attack likelihood (AL) for the vulnerability is calculated using CVSS scores (step S160). The AL is determined in consideration of a tool which can be used by the hacker, a knowledge level of the hacker about the target system, and the value of an asset owned by the target system. That is, if the hacker has a lot of knowledge about the corresponding system and a high-performance tool and the value of data of the system is high, the AL is high, too. However, if a value which can be obtained through the attack is small, the AL is also small.

In an embodiment of the invention, a CVSS (Common Vulnerability Scoring System) is adopted as a system which can evaluate the vulnerability of an information asset, which is common and can be interoperated, by using the CVE information.

The CVSS converts a severity caused by a success of an attack on the corresponding vulnerability into a standardized value. Among CVSS scores, a basic measurement value is evaluated using seven characteristics such as an access vector for a system vulnerability, an access complexity, a value on whether authentication is necessary or not, a confidentiality effect, an integrity effect, an availability effect, and an effect weight.

Among the CVSS scores, the value on whether authentication is necessary or not and the access complexity correspond to the motive or ability of a threat. That is, when the authentication is not necessary or the access complexity is low, the vulnerability can be easily exploited. The other values may correspond to the character of the vulnerability.

The access vector indicates whether or not an access to the vulnerability is available locally only or whether or not an attack can be performed from a remote location. The confidentiality effect, the integrity effect, the availability effect, and the effect weight indicate characteristics of the access.

The vulnerability information handled in the CVE is defined as a dictionary in which information known about vulnerabilities and exposures for information security is arranged, and the vulnerabilities are limited to an information security field. Service and software information identified in each information asset is used to search for a corresponding CVE and CVSS score, and the overall CVSS scores of information assets are summed up so as to calculate a current AL.

Subsequently, the value of the information asset is computed so as to calculate an impact analysis (IM) (step SI 80). The IM indicates an impact on an organization when the information asset is illegally disclosed or falsified or the provision of service becomes impossible. As for the IM, the calculated value of the information asset may be used as it is. Alternately, the IM may be re-computed on the basis of the value of the information asset.

In the present invention, the value of the information asset is determined depending on a policy or is calculated using constituent elements of a computer asset, rather than by a method in which an expert inputs the value. According to this method, the value of the information asset can be calculated automatically using a correlation function between the constituent elements of the computer asset on the basis of the constituent elements. The calculated value of the information asset may be utilized as the IM.

To identify information assets cᵢ of the overall computer assets C of an organization, a passive monitoring method using computer network traffic and an active method using an Nmap tool, and so on may be used (here, cᵢ ε C).

From the viewpoint of software and network, cᵢ can be represented as shown in Table 1.

TABLE 1

| Information | | | | |
|---|---|---|---|---|
| asset | Identifier | Service | Software | Traffic ratio |
| Ci | ipᵢ | svᵢ₁ | swᵢ₁ | TDRᵢ |
| | | svᵢ₂ | swᵢ₂ | |
| | | svᵢ₃ | swᵢ₃ | |
| | | svᵢ₄ | swᵢ₄ | |
| | | . . . | . . . | |
| | | svᵢₖ | swᵢₖ | |

Referring to Table 1, computing the value of the information asset cᵢ may include the steps of: checking an identifier ipᵢ of an information asset cᵢ for a vulnerability; checking a service svᵢₖ provided by the information asset cᵢ and software swᵢₖ operated by the information asset cᵢ; and checking a traffic ratio TDRi used in the checked service svᵢₖ and software swᵢₖ. The traffic may include information on the number of visitors accessing the information asset through an Internet site.

To identify the vulnerability of the software operated by the information asset and relate with the corresponding CVSS score, the vulnerability vector is defined as expressed by Equation 1.

V=(CVE, swᵢₖ, CVSS score) [Equation 1]

Here, the CVE represents a unique identifier for vulnerability, swᵢₖ represents information on software of which the corresponding CVE vulnerability is affected, and the CVSS score represents an effect value of the corresponding vulnerability.

The software information searched in the information asset c; can be used to search a corresponding vulnerability database. This is because information on each software of which the corresponding vulnerability is affected is described in the CVE information. Further, a corresponding CVSS score can be searched for, based on the CVE information. Table 2 shows CVE information and CVSS scores.

TABLE 2

| Information asset | Software | CVE information | CVSS score |
|---|---|---|---|
| cᵢ | swᵢ₁ | CVEᵢ₁₁, . . . | CVSSᵢ₁₁ + . . . |
| | swᵢ₂ | CVEᵢ₂₁, . . . | CVSSᵢ₂₁ + . . . |
| | swᵢ₃ | CVEᵢ₃₁, . . . | CVSSᵢ₃₁ + . . . |
| | swᵢ₄ | CVEᵢ₄₁, . . . | CVSSᵢ₄₁ + . . . |
| | . . . | . . . | . . . |
| | swᵢₖ | CVEᵢₖ₁, . . . | CVSSᵢₖ₁ + . . . |

The vulnerabilities of the information asset cᵢ for the respective softwares are identified so as to calculate an AL, as expressed by Equation 2.

$$A {L}_{C i} = {\sum }_{k} {\sum }_{l} C V S {S}_{i k l} \qquad [ Equation 2 ]$$

When a large number of services are operated by a computer and a lot of softwares are installed in the computer, a large number of CVE vulnerabilities corresponding thereto may be searched. In this case, it is considered that the AL for the computer is high.

When the AL and the IM are calculated through the above-described processes, they are multiplied so as to determine a risk level (RL) for the information asset (step S200). This is expressed by Equation 3.

RL=AL×IM [Equation 3]

The AL and the IM can be calculated on the basis of information on the services and softwares of the identified information asset. Therefore, the RL of the information asset, which is currently operated in a network, can be monitored and evaluated in real time.

According to the method for risk analysis using information asset modeling according to the present invention, it is possible to automate the identification of information assets and to minimize the intervention of an expert or an operator by utilizing the CVSS.

Further, as the information asset is modeled so as to automate the risk calculation for the information asset, time required for calculating a risk level can be shortened, and the vulnerability information can be managed consistently.

While this invention has been described with reference to exemplary embodiments thereof, it will be clear to those of ordinary skill in the art to which the invention pertains that various modifications may be made to the described embodiments without departing from the spirit and scope of the invention as defined in the appended claims and their equivalents.

What is claimed is:

1. A method for risk analysis using information asset modeling, the method comprising the steps of:
(a) identifying an information asset which uses or provides a network service;
(b) identifying a threat on the information asset through a computer network;
(c) identifying a vulnerability of the information asset;
(d) calculating an AL (attack likelihood) using a CVSS (Common Vulnerability Scoring System) score obtained by converting a severity caused by a success of an attack on the vulnerability into a standardized value;
(e) computing the value of the information asset so as to calculate an IM (impact analysis); and
(f) multiplying the calculated AL and IM so as to determine an RL (risk level) for the information asset.

2. The method according to claim 1, wherein in step (c), CVE (Common Vulnerabilities & Exposures) identifiers are used.

3. The method according to claim 2 further comprising the step of:
extracting a CVSS score from the CVE information, the CVSS score being obtained by scoring the vulnerability, wherein the extracting of the CVSS score is performed between steps (c) and (d).

4. The method according to claim 1, wherein step (e) includes the steps of:
checking an identifier of the information asset for the vulnerability;
checking a service provided by the information asset and software operated by the information asset; and
checking a traffic ratio used in the checked service and software so as to compute the value of the information asset.

5. The method according to claim 4, wherein the traffic includes information on the number of visitors who get access to the information asset through an Internet site.

6. The method according to claim 1, wherein a path of the threat on the information asset is a logic access through the computer network.
